(19) United States
(12) Patent Application Publication
(10) Pub. No.: US 2010/0319483 A1
(43) Pub. Date: Dec. 23, 2010

(54) Pivot assembly between treadle and bicycle crank

(75) Inventor: Wen-Hwa Lin, Taichung Hsien (TW)

Correspondence Address: CHARLES E. BAXLEY, ESQUIRE, 90 JOHN STREET, SUITE 403, NEW YORK, NY, 10038, US

(73) Assignee: VP Components Co., Ltd.

(21) Appl. No.: 12/456,483

(22) Filed: Jun. 17, 2009

(51) Int. Cl. G05G 1/30

(52) U.S. Cl. 74/594.4

(57) ABSTRACT

A pivot assembly for coupling a treadle with a bicycle crank is disclosed. The pivot assembly includes a circular seat for being coupled with the crank. Each of two buckle rings received in the circular seat uses a wedge to engage with a connecting shaft of the treadle. By pressing the two buckle rings inward, the wedges leave the connecting shaft so the treadle can be assembled to or disassembled from the crank.

### BACKGROUND OF THE INVENTION

1. Technical Field

The present invention relates to bicycle parts, and more particularly, to a pivot assembly for coupling a treadle with a bicycle crank. The pivot assembly is easy to assemble and disassemble so as to benefit bicycle manufacturers by reducing assembling time and so as to allow a bicycle user to easily change treadles by himself/herself without using additional tools.

2. Description of Related Art

A known device for coupling a treadle with a bicycle crank can be seen in FIG. 1. The known device comprises a treadle shaft 11 to be combined with a treadle 10 and a connector 21 to be combined with a bicycle crank 20. The treadle 10 is designed to revolve on the treadle shaft 11 freely and the connector 21 has one end provided with a threaded segment 22 for being coupled with a threaded hole 23 formed on the crank 20. The connector 21 has an opposite end formed with a hole 24 for receiving the treadle shaft 11, wherein a wall defining the hole 24 is provided with a plurality of balls 25 that are annularly arranged. The balls 25 are controlled by a controlling ring 26 attached to an exterior of the connector 21 for moving toward or away an axis of the connector 21. When moving toward the axis of the connector 21, each said ball 25 partially projects from the hole 24 and gets coupled with a corresponding ball recess 12 formed on the treadle shaft 11, so that the treadle shaft 11 is combined with the connector 21. When moving away the axis of the connector 21, each said ball 25 no more exposes in the hole 24 and leaves the corresponding ball recess 12, so that the treadle shaft 11 is free from the engagement with the connector 21.

The conventional connector 21 composed of tiny springs, recesses, rings and other positioning elements is structurally complicated and difficult to assemble. Nevertheless, a defective connector 21 can significantly increase time consumption of bicycle assembling process and raise failure rate of bicycle assembling process. Besides, once the treadle 10 is coupled with the crank 20, the coupling problem between the controlling ring 26 and the balls 25 can render the treadle shaft 11 jammed in the connector 21 and the treadle 10 can be no more disassembled from the crank 20.

### SUMMARY OF THE INVENTION

The primary objective of the present invention is to provide a pivot assembly between a treadle and a bicycle crank, wherein the pivot assembly is simple in structure and easy to use, so as to allow a bicycle user to assemble and disassemble the treadle on his/her own. When applied to a folding bicycle, the disclosed pivot assembly allows a treadle to be easily detached so as to facilitate storage of the collapsed bicycle.

According to the present invention, a pivot assembly for coupling a treadle with a crank of a bicycle comprises: a circular seat, installed therein two transversely shiftable buckle rings and having two pressing blocks peripherally attached thereto for shifting the two buckle rings; and a pivot shaft, having two slots and passing through the buckle rings so that the buckle rings have wedges thereof normally engaged with the slots. Thereby, when the pressing blocks are pressed, the wedges leave the slots so as to allow a connecting shaft of the treadle to enter the pivot shaft. When the pressing blocks are released, the wedges engage with the slots again and fit in a groove formed on the connecting shaft so that the treadle and the pivot shaft are combined.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawing, wherein:

FIG. 1 shows a known device for coupling a bicycle treadle with a crank;

FIG. 2 is an exploded view of a pivot assembly according to the present invention;

FIG. 3 shows the pivot assembly, a bicycle treadle, and a crank;

FIG. 4 is a vertical sectional view of the pivot assembly;

FIG. 5 is another vertical sectional view of the pivot assembly showing the pivot assembly in operation;

FIG. 6 is a horizontal sectional of the pivot assembly; and

FIG. 7 is another horizontal sectional view of the pivot assembly showing the pivot assembly in operation.

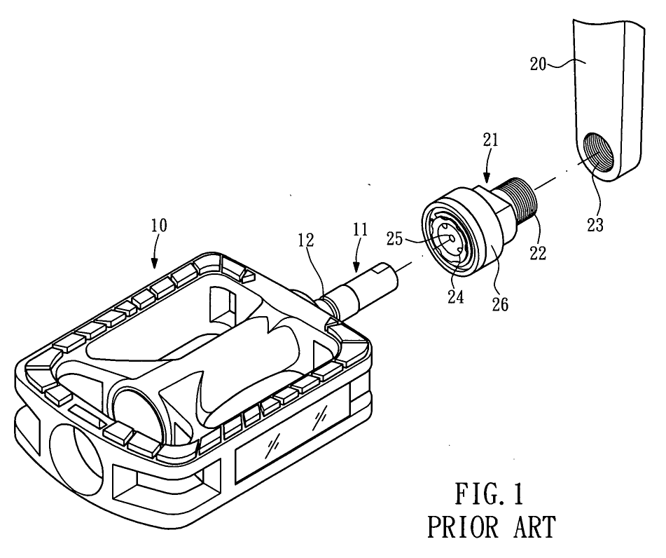

### DETAILED DESCRIPTION OF THE PREFERRED EMBODIMENT

While a preferred embodiment provided hereinafter for illustrating the concept of the present invention as described above, it is to be understood that the components of the embodiment shown in the accompanying drawings are depicted for the sake of easy explanation and need not to be made in scale.

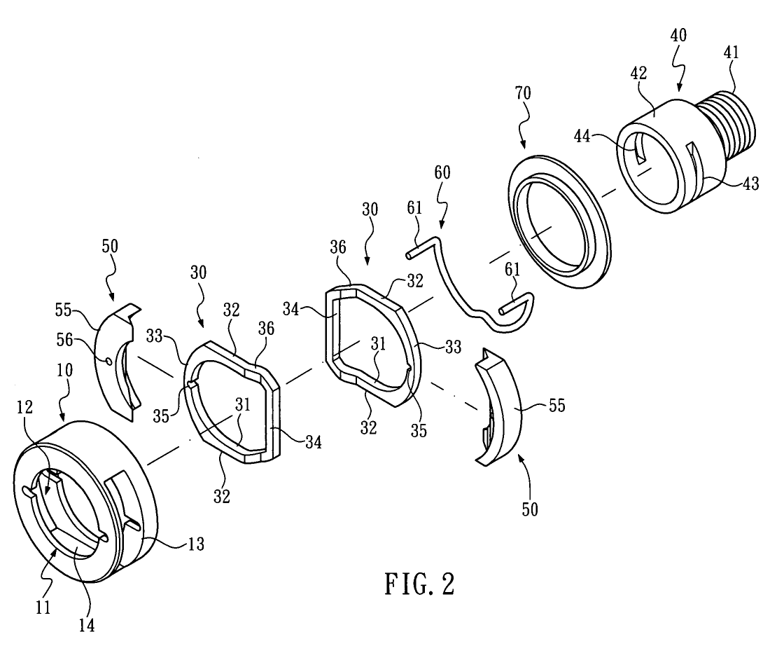

Please refer to FIGS. 2, 3, 4 and 6 for a pivot assembly of the present invention. The pivot assembly comprises a circular seat 10, two buckle rings 30, a pivot shaft 40, two pressing blocks 50, a semicircular spring 60, and an annular cap 70.

The circular seat 10 has an axially extending through hole 11 and an accommodating space 12 formed in the circular seat 10. The through hole 11 and the accommodating space 12 are intercommunicated. Two openings 13 are formed on an outer periphery of the circular seat 10 and diametrically opposite to each other and intercommunicated with the accommodating space 12. In addition, a pair of straight inner walls 14 is formed in the circular seat 10 to flank the accommodating space 12.

Each of the two buckle rings 30 has a generally annular body 31. The annular body 31 includes two straight outer walls 32 parallel to each other, an arched abutting portion 33 and a bar-shaped wedge 34. A pair of bent portions 36 is formed at the border of the wedge 34 and the body 31 so that the wedge 34 is not level with the abutting portion 33 and the body 31. The two buckle rings 30 are piled and received in the accommodating space 12 of the circular seat 10 together in the manner that one of the buckle ring 30 has its abutting portion 33 adjacent to the wedge 34 of the other buckle ring 30 while the straight outer walls 32 contacting the straight inner walls 14 of the circular seat 10, so that the two buckle rings 30 are retained from rotating in the accommodating space 12.

The pivot shaft 40 has a threaded portion 41 and a socket portion 42 that are coaxially connected. The socket portion 42 passes through the through hole 11 and the accommodating space 12 of the circular seat 10. Each said buckle ring 30 has an inner diameter greater than an outer diameter of the socket portion 42 so that the buckle rings 30 are allowed to transversely shift in the accommodating space 12. The socket portion 42 of the pivot shaft 40 is peripherally formed with a first slot 43 and a second slot 44 that are diametrically opposite on the socket portion 42.

Each of the two pressing blocks 50 is an arched member having an outer side formed as an arched wall 55 matching an outer periphery of the circular seat 10 and an inner side provided with a first stair 51, a second stair 52, and a third stair 53. The two pressing blocks 50 are settled in the two openings 13 of the circular seat 10, respectively, with their first stairs 51 receiving the abutting portions 33 of the two buckle rings 30 and with their second stairs 52 abutting on the wedges 34.

The semicircular spring 60 is deposited in the circular seat 10 with two pin portions 61 thereof piercing through two holes 56, 35 preformed on the pressing blocks 50 and the buckle rings 30.

The annular cap 70 is coupled to the circular seat 10 in a close fit so as to position the spring 60.

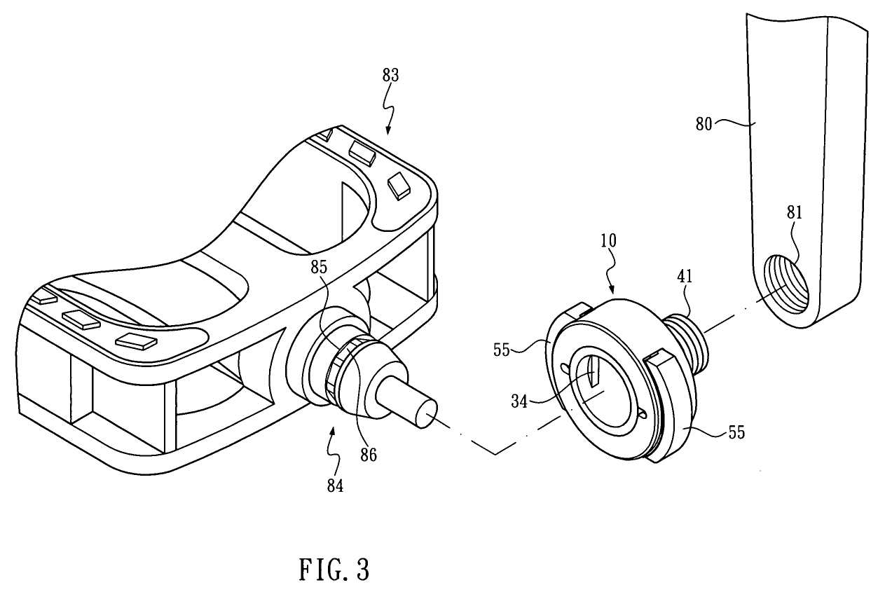

Referring to FIG. 3, in use, the pivot assembly has its threaded portion 41 on the pivot shaft 40 coupled with a threaded hole 81 formed on a crank 80, and has its socket portion 42 mounted around a connecting shaft 84 of the treadle 83. The connecting shaft 84 is peripherally formed with a groove 85 that has a bottom includes at least two flat retaining planes 86.

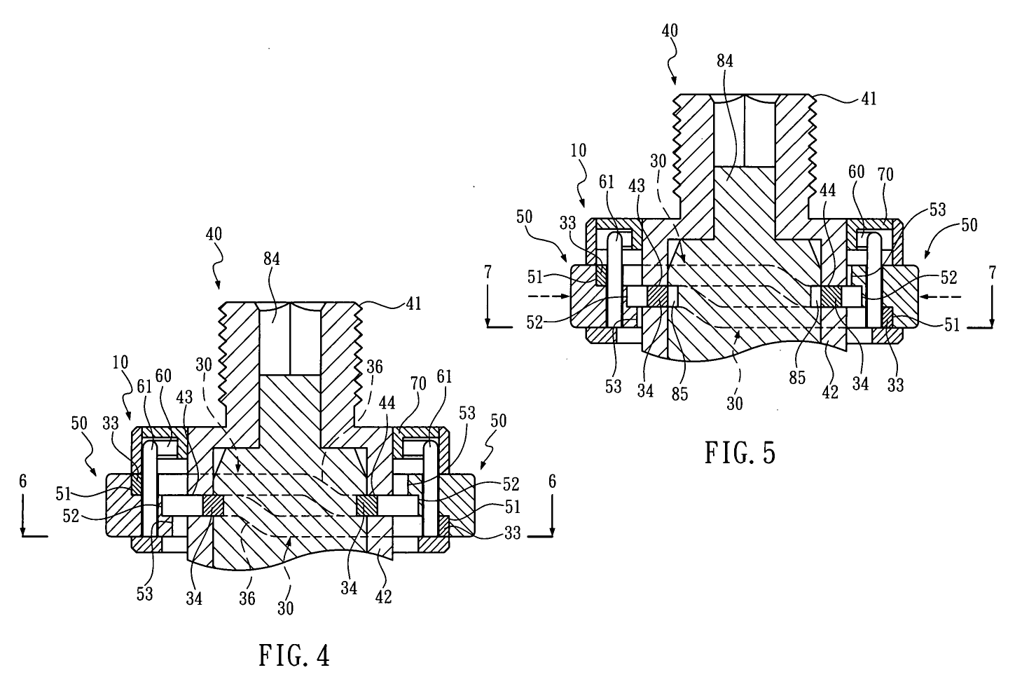

Seeing FIGS. 4 and 6, the two pressing blocks 50 are normally pushed outward and jutting out of the outer periphery of the circular seat 10 by the spring 60, so that the two buckle rings 30 are pulled outward to have the wedges 34 entering the first slot 43 and the second slot 44 and thus jutting out of the inner wall of the socket portion 42. Consequently, the two wedges 34 jutting out of the inner wall of the socket portion 42 are received in the groove 85 so as to be abutted, and thus retained by the two retaining planes 86.

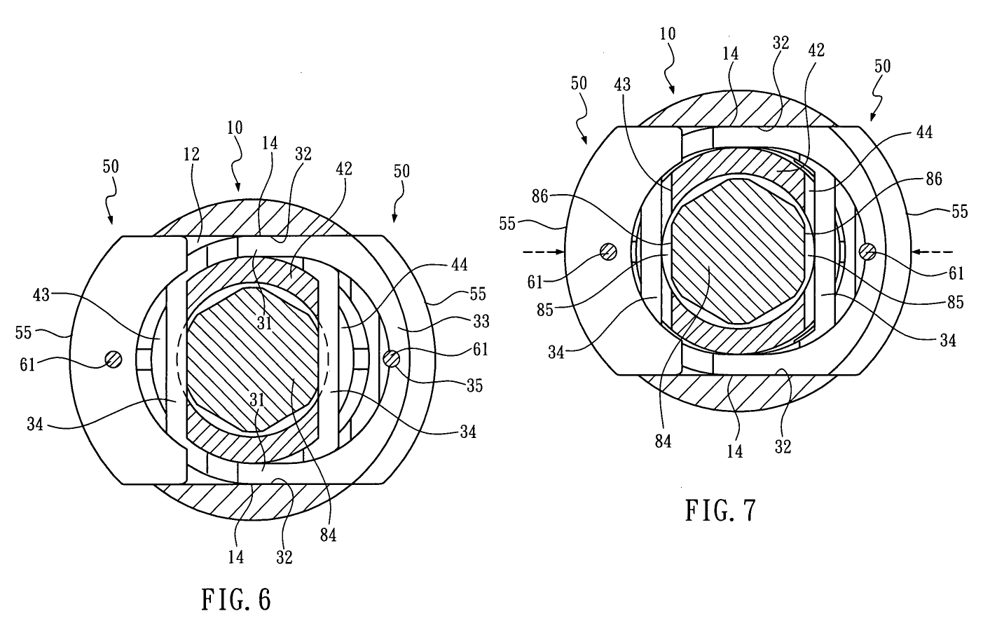

As can be seen in FIGS. 5 and 7, to disassemble the treadle 83, the two pressing blocks 50 can be pressed inward so that the two buckle rings 30 shift in converse directions to make the two wedges 34 move onto the second stairs 52 of the pressing blocks 50. At this time, the wedges 34 leaving the retaining planes 86 and the groove 85 of the connecting shaft 84 allow the treadle 83 to move away from the socket portion 42 along an axis of the connecting shaft 84. The bent portions 36 on the relatively shifting buckle rings 30 facilitate reducing the contact area between the buckle rings 30, thereby minimizing the abrasion of the buckle rings 30.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A pivot assembly for coupling a treadle with a bicycle crank, the pivot assembly comprising:
a circular seat, having an axially extending through hole and an accommodating space formed in the circular seat that are intercommunicated, wherein two openings are diametrically opposite on an outer periphery of the circular seat and intercommunicated with the accommodating space;
two buckle rings, each having an annular body, and an arched abutting portion as well as a bar-shaped wedge formed at two ends of the body, wherein the two buckle rings are such piled and received in the accommodating space of the circular seat together that each of the buckle ring has the abutting portion adjacent to the wedge of the other buckle ring;
a pivot shaft, having a threaded portion and a socket portion that are coaxially connected, wherein the socket portion passes through the through hole and the accommodating space of the circular seat, the socket portion of the pivot shaft being peripherally formed with a first slot and a second slot that are diametrically opposite on the socket portion;
two pressing blocks, each received in one said opening of the circular seat and having an inner side provided with a first stair for receiving the abutting portion of a said buckle ring;
a semicircular spring, deposited at a side of the circular seat with two pin portions thereof piercing through two holes preformed on the pressing blocks and the buckle rings; and
an annular cap, coupled to the side of the circular seat in a close fit so as to position the spring.

2. The pivot assembly of claim 1, wherein a pair of straight inner walls is formed in the circular seat to flank the accommodating space and the body of each said buckle ring includes two straight outer walls parallel to each other for contacting the inner walls of the circular seat.

3. The pivot assembly of claim 1, wherein a pair of bent portions is formed at borders of the wedge and the body so that the wedge is not level with the abutting portion and the body.

4. The pivot assembly of claim 1, wherein each of the two pressing blocks has an outer side formed as an arched wall for matching an outer periphery of the circular seat.

5. The pivot assembly of claim 1, wherein each of the two pressing blocks has an inner side provided with a first stair, a second stair, and a third stair, the second stair being corresponding to the wedge.
